(19) United States
(12) Patent Application Publication
(10) Pub. No.: US 2017/0159691 A1
(43) Pub. Date: Jun. 8, 2017

(54) PLUGS WITH DIMENSIONAL TOLERANCE FOR FILLING PERFECTLY AND IMPERFECTLY DRILLED HOLES

(71) Applicant: Robert J. Pelc, JR., Sarasota, FL (US)

(72) Inventor: Robert J. Pelc, JR., Sarasota, FL (US)

(73) Assignee: The Ipe Clip Fastener Company, LLC, Bradenton, FL (US)

(21) Appl. No.: 15/436,933

(22) Filed: Feb. 20, 2017

Related U.S. Application Data
(63) Continuation-in-part of application No. 14/172,076, filed on Feb. 4, 2014.
Application No. 14/172,076 is a continuation-in-part of application No. 13/144,563, filed on Jul. 14, 2011, now abandoned.
(60) Provisional application No. 61/145,458, filed on Jan. 16, 2009.

(51) Int. Cl. F16B 13/02

(52) U.S. Cl. CPC F16B 13/02

(57) ABSTRACT

Plugs with a high dimensional tolerance of about +/−33 percent for successfully plugging holes even if the holes were miss-drilled to have diameters that vary up to thirty-three percent smaller or larger from the specified hole/plug size of any chosen material, tapered to approximately one degree or un-tapered, having a three-dimensionally textured surface made up of elements imparted upon a surface of the plug causing the plug to exert a strong hold-in force of outwardly directed pressure against a side wall of a drilled hole into which the plug is installed keeping the plug within the drilled hole so that the plug does not protrude out of the hole preventing tripping hazards when the hole is drilled in walking surfaces all without requiring the addition of a glue, special tools, or special fasteners. The plug has a 30 second or less installation time.

### CROSS-REFERENCE TO RELATED APPLICATIONS

This application is a Continuation-In-Part of application Ser. No. 14/172,076 filed on Feb. 4, 2014 which is a Continuation-In-Part of application Ser. No. 13/144,563 filed on Jul. 14, 2011 which is a §371 of PCT/US2010/021036 filed Jan. 14, 2010 which claims benefit of Provisional Application No. 61/145,458 filed on Jan. 16, 2009.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to plugs and, more particularly, to plugs with high dimensional tolerance for successfully plugging perfectly and imperfectly shaped and sized holes even if the holes were miss-drilled to have diameter sizes that vary up to thirty-three percent smaller or larger from the specified hole/plug size.

The background information discussed below is presented to better illustrate the novelty and usefulness of the present invention. This background information is not admitted prior art.

Plugs are standard means used to conceal the holes left by the use of recessed screws or nails as, for example, when decking floor boards are attached to their support studs in the construction of decks, in the making of furniture, wood floor installation, and the like. Presently available plugs are commonly short pieces of wooden dowel that fill a hole drilled to accommodate the use of a screw by applying glue to the end of the wooden dowel that is to be inserted into the hole to be filled and then pounding the glued wooden piece into the screw hole to be filled. After the glue has hardened, the projecting part of the wooden plug is trimmed flush with the wood surface into which the screw was inserted, if necessary. There are plugs available with decorative caps, but these are useful only for use on furniture, as the use of capped plugs in flooring would result in tripping hazards.

### SUMMARY

Presently available wooden plugs used to hide the unsightly holes associated with screw or nail holes in wooden surfaces have many negative aspects, which contribute to both a waste of time and an increase in job cost. Even for a somewhat small-sized project, such as the construction of a small deck, typically hundreds or thousands of plugs are required. The large number of holes that require plugging are drilled by workmen who are facing time constraints and using rudimentary tools. The holes are drilled in rapid succession using commonly available hand drills. The present Inventor watched his installers struggling with improperly sized and/or shaped plugs that are either too loose or too tight for the imperfectly shaped and sized holes into which they are to be installed. Once installed, ineffective plugs, which can be plugs that are too small or too large, often pop out of their holes as the glue used to ostensibly seal them into the hole expands upon drying. Even if the plug extend out of their hole only a fraction of an inch, they can cause a dangerous tripping hazard, are unsightly, and require costly trimming. Oversized plugs tend to break as they are forced into the holes.

Additionally, many of the currently available plugs requirement strict adherence to the kind of screw used to attach, for example, decking floor boards to their support studs, as well as to the depth of the head of the screw (the counterbore), the dimensions and shape of the plug, the material of which the plugs are made, and the specific tools used to install such plugs that are designed and manufactured for specifically sized and shaped holes. These types of requirements add costs in time, labor, and supplies.

After extensive study and research, the present Inventor identified a number of difficulties with the plugs available to him. These difficulties created many drawbacks as they were being installed into a hole. The installation of a standard plug starts when a hole in which a screw or nail is to be inserted is typically drilled using a powered hand held drill. Installers must frequently slow down the hole drilling process in order to attempt to achieve a more uniform hole to try to make traditional plugs fit the hole. Most often though, the installer cannot hold the drill perfectly straight during the process and instead of a perfectly round hole being drilled a slightly misshaped hole is formed as the drill inadvertently wobbles. The resulting hole may often be elliptical because the drill bit may not be completely straight, and the drill bit holding chuck bearings or fittings may not be centered properly. A slightly elliptical hole further complicates the installation of the traditional round wood plug. Traditional plugs are often designed to have sidewalls tapered too severely, and/or they are made slightly oversized in an attempt to provide for a snug fit. This amount of tapering, often several degrees, and the over-sizing of plugs, results however, not in alleviating problems, but in creating additional problems. For example, if the plug is too large for the hole that was drilled, it is likely to break apart as it is being forced into the hole with a hammer and/or the edges around the hole may be damaged. When the standard plug diameter is reduced is size, it often is reduced too much and, thus, cannot fit securely in the drilled hole, thus allowing the glue to push the plug out of the hole during the glue curing process. In other instances, a gap often forms around part, or all, of the periphery of the plug, which results in an aesthetic detraction instead of the intended aesthetically-pleasing concealed-plug appearance. This is very often further exaggerated by the holes frequently being drilled to have a misshapen periphery, as mentioned above. The use of the traditional non-tapered straight plug, however, also poses improper fit problems, as the hole and the plug diameter are rarely a perfect match due to the machining tolerances of the plug and the drilling tolerances of the holes. These problems are exacerbated when the diameter of the plug increases or decreases, which often happens as plugs age and/or are exposed to moisture before being installed and when the size and/or shape of the holes change from hole to hole. Improperly fit plugs often push up and out of the aperture over time which could present tripping hazards on walking surfaces, unsightly imperfections in finished products, and costly repairs.

Accordingly, the present Inventor generated an inventive concept of a new generation of plugs that, if made according to the principles that come from the inventive concept, exert a strong hold-in force of outwardly directed pressure against the bounding walls of perfectly and imperfectly sized and/or shaped drilled holes into which the plug is placed as it is very common during the drilling of holes for the drill to wobble creating a miss-shaped or miss-sized hole. The plugs made according to the inventive principles have a dimensional tolerance of about +/−33 percent of its specified size, causing a plug of the present invention to successfully plug holes that are imperfectly sized and shaped even if the holes are drilled having varying sizes of diameters that can range from zero to about thirty-three percent smaller or larger than the plug specified. The hold-in force of these plugs provide for the plugs to securely fill in recessed screw holes even if the holes are misshapen and have diameters that can be off spec by a +/− having a range of about 33% greater or smaller than the diameter of a hole of a specified size. The hold-in force also provides for the plug remain in the hole even when glue is not used. The principles of the inventive concept require that each plug be a solid plug having a three-dimensionally textured surface made up of elements imparted upon a surface of the plug, said elements causing a strong hold-in force of outwardly directed pressure against the side wall of the drilled hole into which the plug is installed.

The three-dimensionally textured surface made up of elements is a machined unsmooth, textured surface deliberately manufactured as such. Such a structure is, in one case, created by imparting outwardly projecting protuberances about a surface, most often but not limited to, being about the circumferential side surfaces of a plug. In some styles the protuberances are made to be continuous ridges about the side of the plug and in others they are individual knobs, bulges, or nodes, or a combination thereof. The particular design of the protuberances is dictated by the specifications of each job. When the protuberances are ridges, they are aligned perpendicular to the axial direction of the plug, parallel to the axial direction of the plug, or have a wave form, for example. The ridges may be continuous rings about the circumference of the plug or discontinuous. Some protuberances meld into their adjacent protuberances and in other cases the protuberances are distinctly separate from each other. The unsmooth, textured surface manufactured by imparting a structure of related elements upon a surface of the plug may also be imparted to a plug by incising various shapes into one or more sides of a plug. The plugs are produced in any desired form, such as round, straight sided, or tapered, but according to the principles of the inventive concept the degree of tapering is carefully kept to about one degree or so to avoid plugs that are too loose and present the problems described above. Plugs are available with a variety of differently shaped peripheries, such as square-shaped periphery, winged, and oval for example. Each of these variously shaped plugs may be angled to various degrees. The protuberances may occur evenly, randomly, or sporadically spaced about the sides of a plug. Although, plugs most often have their protuberances occurring on their side surfaces, they may, if required, be imparted to the top and/or bottom surfaces of the plug, as well. The strong hold-in force of outwardly directed pressure against the side wall of the drilled hole into which the plug is placed assures that the plugs will not tilt over time, even if subject to heavy foot traffic. The hold-in force also assures that the plugs, as taught herein, will not protrude out of their holes. This is extremely important as protruding plugs would not only be unsightly, they would present dangerous tripping hazards.

The structural design of the plugs of the present invention provide for them to withstand sanding and refinishing many times without losing diameter, as can happen with overly-tapered plugs when used in flooring. If the plugs of the present invention are manufactured from wood, the wood face grain can be displayed on either the sides or ends of a plug. Which type of plug used and how it is installed can make a big difference in the finished look. For example, most store-bought plugs are cut from the end of a dowel, which means that the ends of the plugs display the wood end grain. Having an end grain exposed on the end of the plugs of the present invention would present a grain that is different from the grain of the floor boards which would make the plugs stand out and present an unsightly or careless look to the finished job. Moreover, plugs with end grain exposed on their ends absorb stain or finish like a sponge. This makes the plugs darker than the surrounding wood so they end up standing out like a sore thumb. Additionally, exposed end grains suck up moisture hastening the aging and rotting of the wood. In general, plugs are assumed to be end grain unless side/face grain is specified. Side/face grain, though, should be used consistently in the stair, furniture, and flooring industries, so that the plugs match the grain of the wood in which they are inserted. The plugs of the present invention are always cut so that the ends of the plugs display the face grain of the wood.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1a is an elevation view of a plug according to the principles of the present invention.

FIG. 1b is a perspective view of the top and side of the plug, as shown in FIG. 1.

FIG. 2a is a series of elevation views illustrating examples of various types of manufactured tolerance absorbing textured surfaces manufactured by imparting a structure of related elements upon a surface of the plug.

FIG. 2b is a series of plan views illustrating examples of the various body shapes of plugs made according to the present invention.

FIG. 2C in plan views illustrates two additional types of manufactured tolerance absorbing textured surfaces.

FIG. 2D is a perspective view of a plug to illustrate a wood plug with the face grain displayed on the end.

FIG. 3a is an enlarged view of the invention in use, as shown in FIG. 3b.

FIG. 3b is a small scale view of the invention as shown in FIG. 3a.

### A LIST OF REFERENCE NUMBERS AND THE PARTS TO WHICH THEY REFER

2 Top surface of plug 10.
4 Side surface of plug 10.
6 A series of concentric ridged rings projecting from the plug wall 4.
8 A series of concentric recessed rings in plug wall 4.
10 An example of a plug.
12 Largest diameter ridged ring.
14 A screw.
16 A floorboard.
18 A joist.
20 A recess.
22 Wood face grain on top surface of plug.
24 Incised three-dimensional elements on side of plug.

### DEFINITION

Concentric objects, as used herein, refer to a set of objects that each share the same center, axis, or origin, but are sized so that each object in the series has a radius larger or smaller than the object adjacent to it. An example of a concentric series of inscribed rings, for example, would be the rings inscribed into the outer side surface of a plug, where the diameter of the plug, and, thus, the diameter of the inscribed rings, decreases from the top to the bottom of the plug.
Dimensional tolerance of an absorbing or accepting structured plug, as used herein, refers to the plug's ability to accommodate the differences that can occur in the size and shape of a hole into which a plug is to be inserted during the hole-drilling process. The structure of such a structured plug provides a strong “hold-in” force or outwardly directed pressure against the side wall of the drilled hole into which the plug is placed to hold-in the plug. This hold-in force maintains the plug in the holes when glue is, or is not, used even if the holes are drilled to have diameters that are about thirty-three percent smaller or larger than the plug specified for a given set of holes because of the built-in dimensional tolerance of about +/−33 percent of the plugs of the present invention. Another way of describing this dimensional tolerance is that the hold-in force maintains the plug in the holes even if the drilled hole has a diameter about thirty-three percent greater or smaller than the diameter of plugs being used to fill the holes.
Textured surface, as used herein, refers the principles of the inventive concept that require that the surface of each plug is textured, that is each plug is manufactured to have a deliberately formed, unsmooth surface by imparting a structure of related elements upon a surface of the plug. The structure of related elements generally forms a texture pattern on the surface, but it should be understood that the pattern may be regular or irregular.
Tolerance or Dimensional tolerance, as used herein, refers to the permissible range of variation in the dimension of an object. The accepted permissible range of variation in the dimension of an object depends on the material from which that object is made.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms, as are described above and below or shown in the drawings. Therefore, the embodiments described herein are provided with the understanding that the present disclosure is intended as illustrative and is not intended to limit the invention to the embodiments described.

As stated above, installers are familiar with the inconveniences posed by the commonly available wooden plugs that are used to fill the imperfectly sized and shaped holes drilled for the insertion of screws into boards that are to be attached to their support joists. After considerable study of all of the variables that can be present during the plugging operation, such as the shape and size of plugs, the shape, size, and orientation of the hole that is drilled to receive the attaching screw or nail and the plugs, and the method and means used to drill the hole, the present Inventor identified several reasons for the problems. Relying on his analysis of these variables, the Inventor, from his inventive concept, developed a set of principles that, when followed, make plugs for filling imperfectly sized and shaped holes. Thus, the plugs, as taught herein, either eliminate the identified problems or compensate for the problems. The inventive concept provides the principles for making plugs that have a high degree of dimensional tolerance. In fact, the plugs have a +/− tolerance of about 33 percent. When plugs made following the principles of the present invention are used to fill-in imperfectly drilled screw holes, each plug is able to exert a strong hold-in force of outwardly directed pressure, regardless of the fact that the hole may be miss-happen or miss-sized. In fact, the plugs of the present invention can successfully plug imperfectly drilled holes that have diameters that range between about 33 % greater or smaller than the diameter of the specified drilled hole. The exact percentage of this tolerance, of course, changes a small amount depending on the material used to make the plug. This dimensional tolerance difference between materials is well understood in the art. The outwardly directed pressure exerts force against the side wall of the drilled hole into which the plug is placed to maintain the plug in the hole even when glue is not used. The hold-in force is provided by manufacturing each plug to be tolerance accepting. That is, the principles of the inventive concept of the present invention require a three-dimensional texture comprising a structure of related elements to be imparted to a surface of each plug. That is, each plug is adapted to have either outwardly projecting protuberances about a surface, which is most often, the circumferential side surface of the plug or incisions or indentations on that surface. It is to be understood that although the textured surface is the side surface of a plug, there are instances where to top or bottom surface are also treated to having a texture. That is each plug has a deliberately manufactured, non-smooth textured surface that is caused by imparting a structure of related elements upon one or more of its surfaces. It is the texture imparted to each plug that provides the tolerance acceptance. If the hole into which the plug is inserted is larger than specified, the texture forming elements of the plug expand to fill the space. If the hole into which the plug is inserted is smaller than specified, the elements have the space provided by recesses between elements to collapse. Elements that are protuberances may take a variety of shapes and designs and include rings, ridges, and nodes, for example. The orientation of the ridges can be circumferential, that is aligned perpendicular to the axial direction of the plug, aligned parallel to the axial direction of the plug, or have a wave form, for example. The protuberances comprise continuous ringed ridges about the side of the plug or are individual knobs, bulges, or nodes, or a combination thereof. The ridges or incisions may be spaced with relative regularity or irregularity with regard to one another. The ridges or incisions may cross each other. The plugs are produced in required forms, such as having their peripheries be round, oval, square, rectangular, or irregular with side surfaces that can be straight or tapered, keeping in mind that the tapering should be kept to a minimum. If needed, plugs of this invention may be angled to various degrees. One example, is besides the more typical round plug, some plugs may have a winged, shape or may be angled to conform to a particular shape of a hole. Some special needs include plugs with protuberances or incisions on only an isolated area of a plug. Plugs, made according to the principles of the present invention, may be tapered, but when used in straight-sided holes the taper is always kept to a minimum to avoid having the plug leave a gap, that may be fill with water and be a cause of rot to the material in which the plug is positioned. It is preferred that plugs meant for use in straight-sided holes, the taper is kept close to one degree of taper.

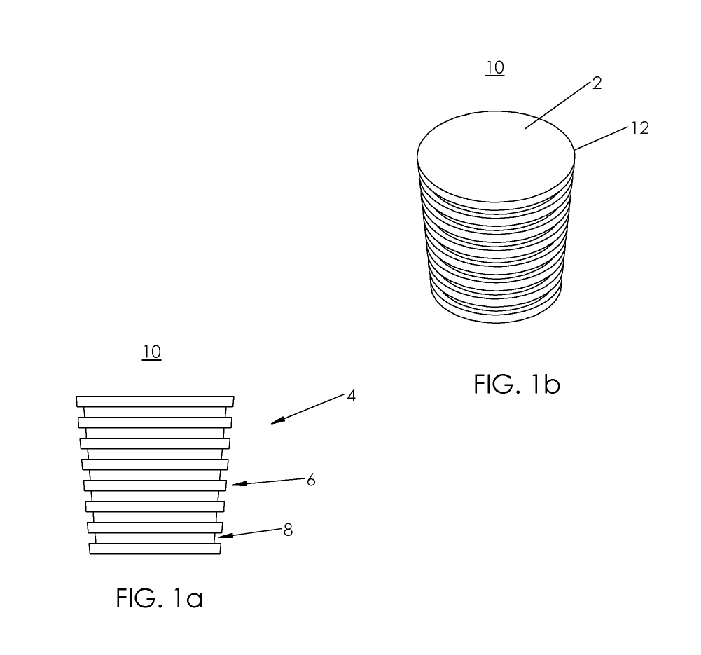

FIG. 1a, an elevation view, and FIG. 1b, a perspective view, illustrate one example of a plug made according to the principles of the present invention. Plug 10, in this example, has a series of spaced recesses 8 that occur between each set of concentric, outwardly radially projecting, dimensional tolerance ringed ridges 6 that are formed about side surfaces 4 of plug 10. In this illustration, plug 10 is tapered, approximately one degree, so that ringed ridge 12, at the top edge of plug 10, has the larger diameter of the series of ringed ridges that occur to the bottom of the plug. As illustrated, ringed ridge 12 forms the defining outer edge of top surface 2. Note that top surface 2 is a smooth, flat surface. This is an important feature, as any protrusion extending upward out of the board surface could be the cause of a tripping hazard if the board is a floor board, or be the cause of an unsightly protrusion if the board is a wall or other non-floor surface. Being a tapered plug, the ringed ridges decrease in diameter from ring ridge 12 toward the bottom of the plug. This design results in a series of ringed recesses alternating with the ringed ridges. Thus, one method of making such a “ringed” plug, involves sculpting a series of spaced recesses into the side of an otherwise smooth-sided plug to produce a series of projecting, dimensional tolerance absorbing, ringed ridge elements. Such ringed ridges are referred to as “hold-in” rings or protuberances. Regardless of the process of making, such dimensional tolerance absorbing elements provide a firm hold-in power for the plug, acting much like barbs on a fish hook to hold each plug in its hole. Increased hold-in power is achieved by this style of plugs even when the hole is improperly drilled or slightly elliptical, as is often the case in holes drilled by hand on the jobsite or in a small workshop, even if the holes differ in their shapes, sizes in their diameters because the plugs of the present invention have a dimensional tolerance of about 33 percent, which means that a plug can successfully plug a hole having a diameter that is 33 percent greater or smaller than the diameter of a hole drilled perfectly to the specified size. It is well understood that the accepted permissible range of variation of dimensions, i.e. dimensional tolerance, of an object depends on the material from which that object is made. Depending upon the material from which a plug is made, the hold-in protuberance design provides for plugs to be installed without any glue being required, thus eliminating the messy, costly, and time-consuming requirement of gluing the plug into a hole. Eliminating the glue is made possible by the high hold-in force the protuberances of the plug exert against the inner side wall of the drilled hole. It should be noted that standard plugs, those that do not have tolerance absorbing elements such as are required by the present invention, often pop out of the hole when glue is not used due to an improperly sized hole, moisture in the plug, or the plugs aging, for example. Additionally, standard plugs can also be forced out of their hole when glued if the glue is polyurethane based glue. Polyurethane based glues expand as they dry; forcing many improperly sized traditional plugs out of the hole which they are plugging. When this happens some of the glue is deposited onto the finished surface resulting in unsightly surface staining. The hold-in ring plugs made according to the principles of the present invention are more consistently held in place even when glue is, or is not, used with the plug.

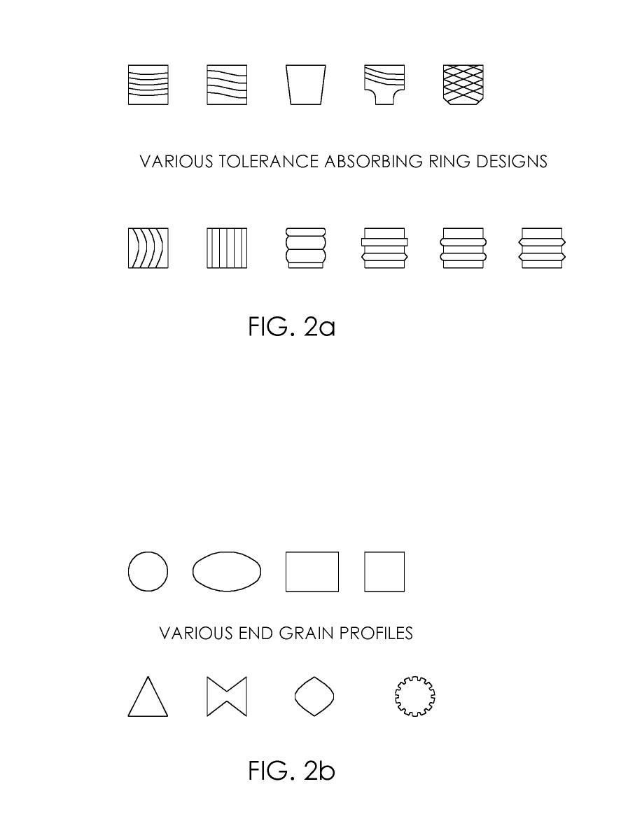

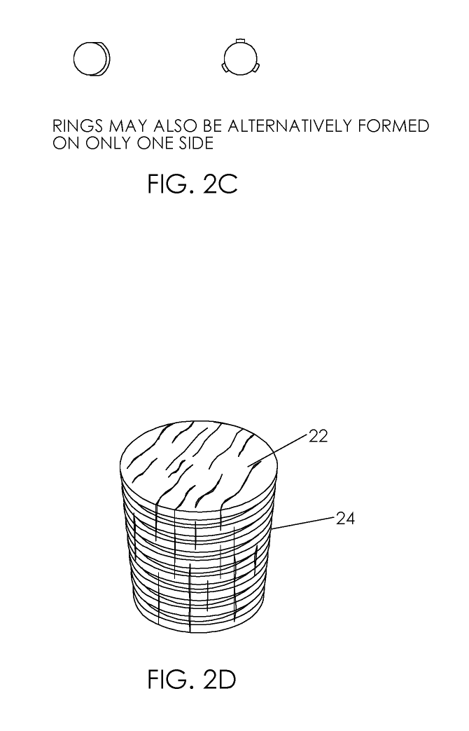

FIG. 2a, a series of elevation views, illustrate a variety of dimensional tolerance absorbing elements that follow the principles of the present invention in addition to the elements shown in FIGS. 1a and 1b. It should be appreciated that the inventive concept does not require the projecting rings or ridge elements of the present invention to conform to the general notion of a ring. The principles of the present require each plug to have a manufactured three-dimensionally textured surface. In the examples given in the drawings, each plug is provided with hold-in elements that can be either protuberances or incisions or both. The manufactured hold-in protuberance elements are formed in a variety of dimensions and/or shapes to achieve different levels of tolerance absorption and hold-in power. That is, some of the protuberances project further out than others, or alternatively, the recesses can be incised to depths that are dictated by job specification. Some element designs include protuberances that are parallel to the axial direction of the plug, while others have protuberances that are perpendicular to the axial direction of the plug, other protuberances are at various angles to the axial direction of the plug, and some plugs have protuberances oriented in a combination of angles. The tolerance absorbing three-dimensionally textured plug surfaces enables each plug to conform to non-round, elliptically-shaped, or slightly improperly sized holes to reduce or eliminate the gaps that are likely to form around a standard smooth sided round plug in similar situations. The three-dimensional tolerance absorbing structured plug surface may compress on one side of the elliptical hole and stay expanded on the opposing side to achieve the much desired aesthetic look of a plug that does not have any gap around it. The configurations of the plug's surfaces also help to retain glue in the hole, thus reducing or eliminating glue being squeezed out onto the workpiece surface during the glue curing process. Reducing or eliminating glue squeeze-out is an important time saving achievement for plug installation as it reduces unnecessary sanding of the surface and keeps the work surface from being stained by the glue. The unique design of the three-dimensional tolerance absorbing hold-in surface configuration achieves a more consistently firm, uniform fit of the plug to the imperfectly drilled hole into which it is inserted, providing for the plug to be retained in the hole as intended. The hold-in plug construction further assists in holding the plug firmly in the hole by exerting an expansion force against the wall of the hole as the plug expands due to the absorption of moisture during seasonal and weather changes.

FIG. 2b, a series of plan views, illustrates the variety of body shapes possible for the plugs according to the present invention. Each of the body shapes may be manufactured having protuberances or incisions in various shapes including square, round, pointed, wavy, free-form, and elliptical designs. The protuberance may be consistently or sporadically spaced. There may be incised rings or ridges around part or the entire perimeter of the plug. The rings or ridges may be a combination of different shapes or sizes used in conjunction on the same device. Each protuberance or incision may vary in size on different sides of the plug. The protuberance or incision may be vertical, horizontal, diagonal, wavy, congruent, incongruent, free-form, or any multiple combination thereof. The protuberances or incisions may be single or multiple and may resemble knobs or bulges to meet various job specifications. Variations of the present invention include dimensional tolerance absorbing protuberance or incision elements formed on plugs with sides that are straight, tapered, concave, convex, stepped, wavy, any combination thereof, or free-form. The preferred end shape of the plug may be round or elliptical, but variations also include square, rectangular, oblong, triangular, polygonal, wavy, or any combination thereof.

FIG. 2C, two plan views, illustrate alternative designs for the three-dimensional elements that are protuberances. The three-dimensional elements contribute to the dimensional tolerance of the plugs of the present invention. Plugs, according to the principles of the present invention, may provide the required holding power by being shaped to have protuberances or incisions on one side of a plug, or on several sides of a plug, as shown.

FIG. 2D, a perspective view, illustrates a tolerance absorbing wood plug with incised three-dimensional elements 24 on the side of the plug and having the face grain 22 of the wood displayed on the top surface of the plug. Face grained plug ends have the advantage of tending to absorb stain at the same rate as the surrounding wood for a less obtrusive finish of the floor, unlike traditional end grain wood plugs which often turn darker than the surrounding floor when stained. Additionally, face grained plugs do not absorb moisture as do end grained plug surfaces.

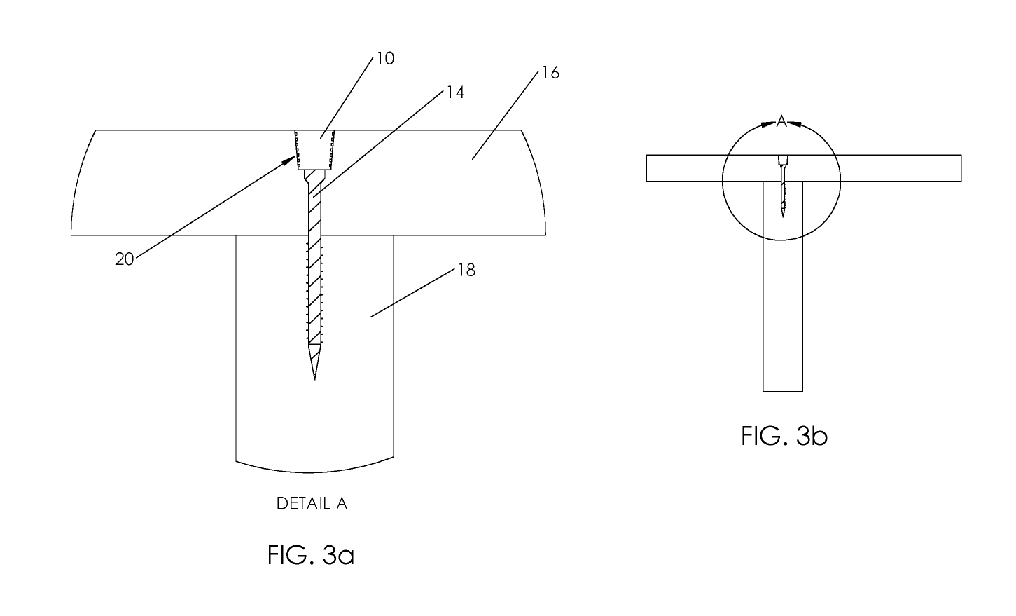

FIG. 3a, an enlarged view of the invention shown in FIG. 3b, illustrates the invention plugging a recessed screw-hole. One preferred embodiment is a wooden face grain plug, but other preferred embodiments include variations may include plugs cut or formed from wooden end grain material, composite, plastic, ceramic, metal, or any combination. Moreover, note that the top surface of the installed plug is planar with the surface of the board into which the plug is installed. If the top surface of the installed plug where to protrude above a floor surface it would present tripping hazards and if it extends out from a non-floor surface it would create an unsightly protrusion.

According to the principles of the present invention, the plugs may be manufactured from any material that will satisfy the requirements of the job. Some jobs might require that the presence of the plugs is as invisible as possible. In that case, the plugs are likely to be made from the same material as the surface into which they are being installed, such as a flooring surface. Alternatively, for example, when there is a need for some boards in a floor to be replaced and the replaced boards are not exactly the same as the boards that do not need to be replaced plugs of a different color, shade, or texture would create a diversion and take the eye away from the mismatched boards. In some instances, the plugs may be designed to contrast with the surface into which they are being installed, to be used as a visual distraction, away from imperfections in the floor, for example.

It is to be understood that the plugs of the present invention have many intended uses, such as filling in holes drilled in floors, walls, ceilings, railings, stairs, furniture, or any place where a plug is required or desired. In some uses, the average diameter size of drilled holes intentionally vary. In that case, the average size of the plug made according to the principles of the present invention may also vary. Most commonly available plugs made for filling holes drilled into deck-floorings range in diameter from about ⅜″ (0.375″) in the United States and 10 mm (0.394″) in Europe. Some are a little smaller at ¼″ (0.25″) and some are a little bigger like ½″ (0.50″). The diameter size of the plugs of the present invention ranges from about ⅛″ (0.125″) diameter to 1½″ (1.5″) with each diameter size being able to successfully plug an imperfectly sized drilled hole having a diameter tolerance that can range between about 33% greater or smaller than the diameter of a perfectly drilled hole of a specified size. It is well-accepted that the accepted permissible range of variation, i.e., dimensional tolerance, in the dimension of an object depends on the material from which that object is made and the accepted range of tolerance for a given material is well-documented.

The plugs of the present invention are easy to use. First a hole is drilled into the board to be attached to its support studs. No special tools are required. Any drill commonly used for this purpose is acceptable. A screw or other fastener is then installed through the hole just drilled to anchor the board to its support. Once the fastener is in place, if using glue, a small amount is squirted into the hole. A plug is then positioned over and partially into the hole and hammered in. That usually finishes the job. Using the plugs of the present invention, it should take no longer than 20 seconds to drill a hole, apply glue if desired, and install the plug and be ready to go on to the next hole. Most times, the plug will fit into the hole and be co-planar with the surface into which it was installed. If the surface of a plug is not in perfect alignment with the surface of the board, a quick sanding will have the surface of the plug and the surface of the board in perfect matched alignment.

This is very different from other systems where the fastener must have two different sets of threads, a head with it periphery and underside specially configured, and must be installed to a predetermined depth. The plugs to be used with this system must be dimensioned for a given fastener and must meet several specific dimensions for use with prescribed drivers and must fit the width and depth of the hole exactly so that the surface of the plug and the board into which it is being installed are coplanar by mere insertion, which causes issues because of the tolerance associated with drilling the depth of a hole to an exact dimension causing the plug to either sit too high—causing a tripping hazard when installed on a floor or be aesthetically unpleasing. Moreover, the use of glue is suggested to maintain the plug in place. To limit the penetration depth of the fastener, the body of the driver requires a spring loaded washer to be mounted to it. In fact, in some systems, the counterbore (the part of the hole into which the plug is to be installed, is required to be slightly smaller than the fastener head. These other systems are complicated, require accurately measured installations, fasteners, and tools which means that they require time and expense. Some systems require that the plugs be made of the same material into which they are to be installed. Some plugs are expressly conically tapered so that there will be an annular cavity remaining once the plug is in place. This seems to make an unstable system one where the plug could easily become tilted which means that the outer face of the plug would lose co-planarity with the board. Others require a stepped plug with a wide part and a narrow part made to exact dimensions to coordinate with the fastener used; the height of each part must be of exact dimension also to fit with the predetermined depth to which the fastener is installed. To assure that a fastener is driven to the predetermined depth a stopper must be used to limit the rotation of the drill once the predetermined depth is reached. The plugs must be specially configured. Other systems require compression grooves that are incised deeply into the body of the plug and require the use of glue. Some special use plugs are made out of highly resilient material and to have hollow interiors that can be used to hold special materials, such as termite insecticide. Other specialty plugs are designed to have unique shapes for use in holes that have accepting shapes. These kinds of plugs are too different in structure and function to be compared to the plugs of the present invention.

The system and method of the present invention provides for rapid and easy installation where the entire installation can be complete in significantly less than 30 seconds. The cost of the plugs meets the needs of jobs where thousands of plugs are used. The plugs of the present invention that are used in floor and deck installations are required to be made without caps and surface decorations. The plugs of the present invention may of course be used with equal ease and pleasing results in installations that are other than floor. Glue may be used if desired, but is not required. There is no additional time or financial investment required as no special tools required, such as are required for other systems. The plugs are not required to be specifically configured, neither do the plugs of this invention have to be made to exact dimensions and need not exactly fit the width and depth of the hole into which they are to be installed. If the plugs are seated too high a quick sanding brings them into planarity with the board into which they are inserted. The plugs of the present invention do not need to be expressly conically tapered and do not have to have an annular cavity remaining once the plug is in place, nor do the plugs of the present invention require the plug be stepped with a wide part and a narrow part each made to exact dimensions to coordinate with the fastener used. The fastener is not required to have two different sets of threads and need not be installed to a predetermined depth and any driver and any drill suitable for the purpose will work. The driver used does not require either a spring or a stop to control the depth of the fastener as it is being driven through the board into the board's support. The plugs of the present invention do not require prescribed deck screws and drivers, and the counterbore is not required to be smaller than the head of the fastener. The present invention relies on the plugs having manufactured three-dimensional textural elements on the outside surfaces of the plugs to provide the plugs with their hold-in force of outwardly directed pressure and do not require or use compression grooves that are incised deeply into the body of the plug.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A plug for plugging perfectly and imperfectly drilled holes, comprising:
a plug having a dimensional tolerance of about +/−33 percent,
said plug having a textured surface made up of three-dimensional elements created upon said plug,
said elements causing said plug to exert a strong hold-in force of outwardly directed pressure against the side wall of the drilled hole into which said plug will be installed causing said plugs, when used to plug holes, to successfully plug holes miss-drilled to have diameter sizes that vary up to thirty-three percent smaller or larger from the specified hole/plug size.

2. The plug, as recited in claim 1, wherein said plug has a given diameter size ranging from about ⅛″ (0.125″) diameter to 1½″ (1.5″),

3. The plug, as recited in claim 2, wherein said plug has a given diameter size ranging from about a range of ¼″ (0.25″) to ½″ (0.50″)

4. The plug, as recited in claim 3, wherein said three-dimensional elements are protuberances.

5. The plug, as recited in claim 4, wherein said protuberances are about the circumferential surface of said plug.

6. The plug, as recited in claim 5, wherein said protuberances are about the side, top or bottom surfaces of said plug.

7. The plug, as recited in claim 6, wherein said protuberances are ridges.

8. The plug, as recited in claim 7, wherein said protuberances are aligned perpendicular to the axial direction of the plug or parallel to the axial direction of the plug.

9. The plug, as recited in claim 8, wherein said ridges form a series of rings about the circumferential surface of said plug.

10. The plug, as recited in claim 9, wherein said protuberances are distinctly separate from each other.

11. The plug, as recited in claim 10, wherein said protuberances blend into adjacent said protuberances.

12. The plug, as recited in claim 1, further comprising said plug being a plug tapered to approximately 1 degree of taper.

13. The plug, as recited in claim 1, further comprising said plug being a wooden plug.

14. The plug, as recited in claim 13, wherein said plug is tapered to approximately 1 degree of taper.

15. The plug, as recited in claim 14, wherein said plug is made of a manufactured material.

16. The plug, as recited in claim 1, further comprising said elements being elements incised into said plug.

17. The plug, as recited in claim 1, further comprising having a round, straight sided, or tapered form.

18. The plug, as recited in claim 1, further comprising having an installation time of less than 30 seconds.

19. A plug, comprising:
a plug having a dimensional tolerance of about +/−33 percent of its specified size, said plug tapered to approximately one degree,
said plug having a three-dimensionally textured surface made up of elements generated upon said plug,
said elements causing said plug to exert a strong hold-in force of outwardly directed pressure against a side wall of a drilled hole into which the plug is installed causing said plugs, when used to plug holes, to successfully plug holes miss-drilled to have diameter sizes that vary up to thirty-three percent smaller or larger from the specified hole/plug size.

20. A plug, comprising:
a wood plug with dimensional tolerance of about +/−33 percent of its specified size, said plug tapered to approximately one degree,
said plug having a three-dimensionally textured surface made up of elements imparted upon said plug,
said elements causing said plug to exhibit a strong hold-in force of outwardly directed pressure against a side wall of a drilled hole into which the plug is installed causing said plugs, when used to plug holes, to successfully plug holes miss-drilled to have diameter sizes that vary up to thirty-three percent smaller or larger from the specified hole/plug size,
said plug not requiring the addition of a glue, special tools, or special fasteners in its installation.
